(19) United States
(12) Patent Application Publication
(10) Pub. No.: US 2026/0348658 A1
(43) Pub. Date: Nov. 5, 2026

(54) A DRYING ROOM FOR POST HARVESTING PROCESSES, MODULES AND METHODS THEREOF

(71) Applicant: R.P. GROW-TEC INNOVATIONS LTD., Gazit (IL)

(72) Inventors: Shlomy RAZIEL, Kibbutz Gazit (IL); Ori MINES, Kibbutz Gazit (IL); Nir GALANT, Kibbutz Gazit (IL); Omer PINCHUK, Tel-Aviv (IL); Ron AMAR, Shimshit (IL); Ilan HACOHEN, Kibbutz Gadot (IL)

(21) Appl. No.: 19/102,928

(22) PCT Filed: Aug. 10, 2023
(86) PCT No.: PCT/IL2023/050837

§ 371 Date: Feb. 11, 2025

(30) Foreign Application Priority Data
Aug. 11, 2022 (IL) 295573

(51) Int. Cl. F26B 21/50; F26B 21/20; F26B 21/33; F26B 21/35; F26B 21/37

(52) U.S. Cl. CPC F26B 21/50; F26B 21/202; F26B 21/333; F26B 21/35; F26B 21/37

(57) ABSTRACT

A room for drying crops is characterized by a closed plenum enveloping an inner drying volume by means of a ceiling and a set of opposite perforated walls. An air handling unit and EC blowers are in a fluid connection with the closed enveloping plenum. The air handling unit is configured to keep temperature and relative humidity steady within the inner drying volume, at levels of at least ±1.5° C. and ±5.5%, respectively. The EC blowers create a pressure of at least 150 Pascal and airflow velocity of at least 1.5 m/s at the exit of the planum to within the room. Airflow velocity after the encounter of is at least 0.24 m/s. The perforated walls comprise an array of open slots, each of which is characterized by a 120° angle on the plenum side of the wall and 110° on the room side.

### FIELD OF THE INVENTION

The present invention generally pertains to a drying room for post-harvesting processes, modules, and to methods thereof.

### BACKGROUND OF THE INVENTION

Raw vegetables, fruits, and aquatic products have high water activity and are highly susceptible to mechanical damage, microbial spoilage, and environmental conditions thus perishable. Drying is the removal of moisture e.g., reducing water activity from a product, to slow down the pace of deterioration and maintain the quality without damaging the tissue, wholesomeness, and physical appearance of the crops. About 15% of global energy usage in the food sector is for cropping production, see Lamidi, R. O., et al. “Recent advances in sustainable drying of agricultural produce: A review.” Applied energy 233 (2019): 367-385.

Drying uniformity is very much related to product quality, and is measured by crops' temperature, moisture content, color difference, shrinkage, etc. ; see Zhang, Min, et al. “Recent developments in high-quality drying of vegetables, fruits, and aquatic products.” Critical reviews in food science and nutrition 57.6(2017 ): 1239-1255. Nevertheless, the larger the number of flowers intended for drying, the greater the difficulty of creating uniformity without damaging the trichomes and aroma of the flowers.

### SUMMARY OF THE INVENTION

It is hence one object of the invention to disclose a room for drying crops characterized by an efficiency index exceeding 35 kg/m² (kg of a wet crop per floor area), the drying room is characterized by a plenum enveloping an inner drying volume, by means of a ceiling and a set of opposite perforated walls; an air handling unit and one or more EC or ECM blowers are in provided fluid connection with the enveloping plenum. This drying room is further characterized by that at least one of the following is held true: the air handling unit is configured to keep the temperature and relative humidity steady within the inner drying volume, at levels of at least ±1.5° C. and ±5.5%, respectively; the one or more EC blowers are configured, at 60% power, for facilitating (i) pressure of at least 150 Pascal and airflow velocity of at least 1.5 m/s at the exit of the plenum to within the room; and (ii) airflow velocity after the encounter of at least 0.24 m/s; and the perforated walls comprises an array of open slots, each of which is characterized by a 120° angle on the plenum side of the wall and 110° on the room side.

Another object of the invention is to disclose the drying room as defined above, wherein the room is further characterized by at least one module of non-thermal plasma (NTP) configured to kill at least two orders of magnitudes of molds in less than five minutes, by ionizing the airstream flowing within the plenum walls or ceiling.

Another object of the invention is to disclose the drying room as defined in any of the above, wherein the room further comprises at least one tray-rack module.

Another object of the invention is to disclose the drying room as defined in any of the above, wherein the room further comprises at least one tray-rack module is a weighing rack.

Another object of the invention is to disclose the drying room as defined in any of the above, wherein at least one of the following is held true: a rack 60 further comprising at least one drying tray 63, configured by shape and size to be accommodated within said trays-rack; a rack 66 further comprising at least one trellis 67, configured by shape and size to be accommodated within said rack; and a rack 68 further comprising one or more hanging slots or hanging teeth, configured by shape and size to be accommodated within said rack.

Another object of the invention is to disclose the drying room as defined in any of the above, wherein the room further comprises at least two tray-rack modules provided in a multiple-rack system, (e.g., a double-rack system).

Another object of the invention is to disclose the drying room as defined in any of the above, wherein the room further comprises at least one drying tray, configured by shape and size to be accommodated within the tray-rack modules.

Another object of the invention is to disclose the drying room as defined in any of the above, wherein the drying tray comprises an array of ventilation slots in its walls and ventilation holes in its base, the ventilation holes provide between 45% to 75%, (e.g., 60%) of the perforated base area.

Another object of the invention is to disclose the drying room as defined in any of the above, wherein air is forced to flow horizontally, in a laminar or quasi-laminar manner, form the walls, into the drying room, to the weighing racks (60) that are located adjacent to the walls. Each of the racks contains a plurality of perforated drying trays (63), and each of the trays contains a crop to be dried. The trays are stacked upwardly in a vertical manner, having a predefined gap between each two neighboring trays. Flow control is achieved by continuously inflowing dry air in a horizontal manner, through apertures provided in the walls of the trays. Then, the hereto wetted air is further continuously outflow from the trays to the central portion of the drying room and flows vertically to be diverted in a plenum ceiling for further downstream processing.

Additionally, or alternatively, another object of the invention is to disclose the drying room as defined in any of the above, wherein air is forced to flow horizontally, in a laminar or quasi-laminar manner, form the walls, into the drying room, to the weighing racks (66) that are located adjacent to the walls. Each of the racks contains a plurality of perforated drying trellis (67), and each of the trellis carries the crop to be dried. A trellis is e.g., one or more cable-like, forklike, rack-like, a fence-like member, or otherwise a substantially horizontal construction member configured to dry crops hang on it. Flow control is achieved by continuously inflowing dry air in a horizontal manner, through the trellis provided in the walls of the trays. Then, the hereto wetted air is further continuously outflow from the trellis to the central portion of the drying room and flows vertically to be diverted in a plenum ceiling for further downstream processing.

Another object of the invention is to disclose the drying room as defined in any of the above, wherein the room further comprises at least one sensor for detecting at least one parameter selected from a group consisting of air temperature, humidity, wet-bulb temp., AH, relative humidity, crop's water activity, airflow speed, airflow direction, airflow volume, electrical conductivity, sound parameters (speed, pressure level, pitch, duration, loudness, timbre, and texture), parameters of light and electromagnetic radiation, including intensity, spectra, pulses' pattern, continuous wave patterns; additive concentration, weight, including time resolved weight of the rack, the tray and dried crop, analytics, including chemical, microbial and biological detecting or measuring means, and any combination thereof.

Another object of the invention is to disclose the drying room as defined in any of the above, wherein the room further comprises comprising a processor, in communication with at least one sensor; at least one of the four: a database, an airflow controller, the air handling unit and the EC blowers.

Another object of the invention is to disclose the drying room as defined in any of the above, wherein a database is stored in a retrievable manner in a computer-readable medium, the database comprises data selected from a group consisting drying room's parameters, including size, and shape; crop's related parameters, including crop type, its initial water content, required final water content, required temperature range, required humidity range, and required drying rate; outside parameters, including temperature and humidity; time-resolved stored drying room's parameters; parameter related with downstream processing, including drying, filtering, additives adding and NTP emitting parameters; time-resolved sensed, measured or otherwise detected data, and any combination thereof.

Another object of the invention is to disclose the drying room as defined in any of the above, wherein the room is provided useful for drying, sanitizing, moisture controlling and/or enhancing potency of crops, by applying controlled air flow, temperature and humidity regulation and providing real-time feedback control mechanisms, simultaneously eliminating molds and plants pathogens; the feedback control mechanism is operatable in a method comprising steps of defining (101) and storing optimal parameters of a drying process for a given batch or batches of a crop; defining (102) and storing drying rate approved zone; measuring (103) predefined parameters in a continuous or intermittent manner, including weighing (104) dried crop along time; processing (105), by means of an air flow controller, parameters obtained in steps 103 and 104, thereby evaluating if drying rate is optimal, including evaluating if drying rate is either too fast (106) or too slow (107), as compared with drying rate approved zone (102). if drying rate is not optimal (108), redefining airflow parameters, including lowering air temperature, or decreasing air flow; otherwise, if drying rate is optimal, namely is within in a predefined approved zone, drying (109) the crop at same set of parameters until end of process.

Another object of the invention is to disclose the drying room as defined in any of the above, wherein the room further is provided useful for killing crop's pathogens by ionizing the recycled air, without requiring to add any additional chemicals, characterized by an NTP feedback mechanism operatable in a method comprising steps of defining (101) and storing optimal parameters of a drying process for a given batch or batches of a crop; measuring (103) predefined parameters in a continuous or intermittent manner, including weighing (104) dried crop along time; measuring total pathogens in the dried crop, definable e.g., CFU/gr; if total pathogen concentration is greater than a predefined critical value, increasing (111) NTP performances or number of NTP modules.

Another object of the invention is to disclose the drying room as defined in any of the above, wherein the room is provided useful for regulating crops' specification and maximizing its market value, characterized by a feedback mechanism operatable in a method comprising both steps of, by means of the processor, the airflow controller, the air handling unit or the EC blowers, controlling crop temperature to a predefined temperature' allowed zone; by means of the processor, the airflow controller, the air handling unit, the EC blowers, or downstream processing modules, controlling air parameters to a predefined allowed zone.

Another object of the invention is to disclose the drying room as defined in any of the above, wherein the step of controlling air parameters is provided by means selected from a group consisting of adding to or enriching with at least one additive the drying air; drying the air; coalescent and conventional oil separating, liquid receiving and treating, eliminating pathogens by emitting NTP; filtering the air; contacting the air with a material-binding solid-phase or liquid-phase sorbents; bubbling air in a liquid phase for liquid extraction of a material; admixing material-binding agent with the inflowing air.

Another object of the invention is to disclose the drying room as defined in any of the above, wherein the material is selected from a group consisting of oxygen, carbon dioxide, hydroxyl-containing materials, esters, carboxylic acids, fatty acids, amino acids, peptides, terpenes, water-immiscible materials, materials miscible in organic solvents, ethylene, methane, aromatic materials, odors, nitrogen and nitrogen-containing materials, surfactants, volatile organic compounds, toxins, hazard materials, halogens, small particles, dust and fine particles, inorganic matter, pollen, dyes and pigments, insects and organs thereof, contaminations, magnetic materials, viruses, microorganisms, mixtures, and derivatives thereof.

Another object of the invention is to disclose a method of drying crops in an effective manner, where the efficiency index exceeding 35 kg/m² (kg of a wet crop per floor area), the method comprises steps of enveloping an inner drying volume with a plenum of a ceiling and a set of opposite perforated walls; providing an air handling unit and one or more EC blowers in a fluid connection with the enveloping plenum; and at least one of the three: (a) configuring the air handling unit to keep relative humidity and temperature steady within the inner drying volume, at levels of at least ±1.5° C. and ±5.5%, respectively; (b) configuring the one or more EC blowers, at 60% power, for facilitating (i) pressure of at least 150 Pascal and airflow velocity of at least 1.5 m/s at the exit of the planum to within the room; and (ii) airflow velocity after the encounter of at least 0.24 m/s; and (c) providing the perforated walls with an array of open slots, each of which is are characterized by a 120° angle on the plenum side of the wall and 110° on the room side.

Another object of the invention is to disclose the method as defined above, wherein the method further characterized by a step of providing the drying room with at least one module of NTP configured to kill at least two orders of magnitudes of molds in a less than five minutes, by ionizing the airstream flowing within the plenum walls or ceiling.

Another object of the invention is to disclose the method as defined in any of the above, wherein the method further comprises a step of providing the inner drying volume with at least one tray-rack module.

Another object of the invention is to disclose the method as defined in any of the above, wherein at least one tray-rack module is a weighing rack.

Another object of the invention is to disclose the method as defined in any of the above, wherein at least one of the following is held true: a weighing rack 60 comprises a metal frame 61 with metal-made shelves-like construction, configured to carry a stack of parallelly set drying trays 63, 64; a weighing rack 66 comprises a metal frame 61 with one or more metal-made trellis 67; and, a weighing rack 68 comprises a metal frame 61 with one or more metal-made slots or teeth 67.

Another object of the invention is to disclose the method as defined in any of the above, wherein the method further comprises a step of providing at least two trays-rack in a multiple-rack system, e.g., a double-rack system, and a triple-rack mechanism.

Another object of the invention is to disclose the method as defined in any of the above, wherein the method further comprises a step of configuring at least one drying tray, by means of shape and size, to be accommodated within the tray-rack.

Another object of the invention is to disclose the method as defined in any of the above, wherein the method further comprises a step of providing the drying tray with an array of ventilation slots in its walls and ventilation holes in its base, namely its bottom portion, in a measure that the ventilation holes provide between 45% to 75%, (e.g., 60%) of the perforated base area.

Another object of the invention is to disclose the method as defined in any of the above, wherein the method further comprising steps of providing the inner volume with at least one trays-rack, accommodating a vertical stack of drying trays; forcing dry air to flow within the plenum, outside the inner volume by means of the EC blowers, and cycling the same to continuously inflow in a horizontal manner towards the inner volume, via an array of slots provided at opposite walls of the plenum; flowing the stream of dry air horizontally in a laminar manner, towards the racks, and more specifically, towards gaps provided between each two neighboring trays; there, adjacent and within to the gaps, facilitating an horizontal air flow to change its course, namely for flowing vertically via an array of apertures provided within the bottom portion of each of the drying trays loadable with crop to be dried; hence, facilitating flow of an air stream in a continuous and laminar manner, from tray's bottom, via the crop, to an upwardly located neighboring tray, and so on and so forth; then, outflowing the hereto wetted air from the racks and diverting the same to a plenum ceiling for further downstream processing.

Another object of the invention is to disclose the method as defined in any of the above, wherein the method further comprises a step of providing at least one sensor for detecting at least one parameter selected from a group consisting of air temperature, humidity, wet-bulb temp., AH, relative humidity, crop's water activity, airflow speed, airflow direction, airflow volume, electrical conductivity, sound parameters (speed, pressure level, pitch, duration, loudness, timbre, and texture), parameters of light and electromagnetic radiation, including intensity, spectra, pulses' pattern, continuous wave patterns; additive concentration, weight, including time-resolved weight of the rack, the tray and dried crop, analytics, including chemical, microbial and biological detecting or measuring means, and any combination thereof.

Another object of the invention is to disclose the method as defined in any of the above, wherein the method further comprises a step of communicating a processor with the at least one sensor and with at least one of the four: a database, an airflow controller, the air handling unit and the EC blowers.

Another object of the invention is to disclose the method as defined in any of the above, wherein the method further comprises one or more steps of storing the database in a retrievable manner in a computer-readable medium; and providing the database to comprises data selected from a group consisting drying room's parameters, including size, and shape; crop's related parameters, including crop type, its initial water content, required final water content, required temperature range, required humidity range, and required drying rate; outside parameters, including temperature and humidity; time-resolved stored drying room's parameters; parameter related with downstream processing, including drying, filtering, additives adding and NTP emitting parameters; time-resolved sensed, measured or otherwise detected data, and any combination thereof.

Another object of the invention is to disclose the method as defined in any of the above, wherein the method provided useful for drying, sanitizing, moisture-controlling and/or enhancing potency of crops, by applying controlled air flow, temperature, and humidity regulation and providing real-time feedback control mechanisms, simultaneously eliminating molds and plants pathogens; the feedback control mechanism is operatable by steps of defining (101) and storing optimal parameters of a drying process for a given batch or batches of a crop; defining (102) and storing drying rate approved zone; measuring (103) predefined parameters in a continuous or intermittent manner, including weighing (104) dried crop along time; processing (105), by means of an airflow controller, parameters obtained in steps 103 and 104, thereby evaluating if drying rate is optimal, including evaluating if drying rate is either too fast (106) or too slow (107), as compared with drying rate approved zone (102). If drying rate is not optimal (108), redefining airflow parameters, including lowering air temperature, or decreasing air flow; otherwise, if drying rate is optimal, namely is within in a predefined approved zone, drying (109) the crop at same set of parameters until end of process.

Another object of the invention is to disclose the method as defined in any of the above, wherein the method provided useful for killing crop's pathogens by ionizing the recycled air, without requiring to add any additional chemicals, characterized by an NTP feedback mechanism operatable by steps of defining (101) and storing optimal parameters of a drying process for a given batch or batches of a crop; measuring (103) predefined parameters in a continuous or intermittent manner, including weighing (104) dried crop along time; measuring total pathogens in the dried crop. If total pathogen concentration is greater than a predefined critical value, increasing (111) NTP performances or number of NTP modules.

Another object of the invention is to disclose the method as defined in any of the above, wherein the method provided useful for regulating crops' specification and maximizing its market value, characterized by a feedback mechanism operatable in a method comprising both steps of, by means of the processor, the airflow controller, the air handling unit or the EC blowers, controlling crop temperature to a predefined temperature' allowed zone; and by means of the processor, the airflow controller, the air handling unit, the EC blowers, or downstream processing modules, controlling air parameters to a predefined allowed zone.

Another object of the invention is to disclose the method as defined in any of the above, wherein the step of controlling air parameters is provided by means selected from a group consisting of adding to or enriching with at least one additive the drying air; drying the air; coalescent and conventional oil separating, liquid receiving and treating, eliminating pathogens by emitting NTP; filtering he air; contacting the air with a material-binding solid-phase or liquid-phase sorbents; bubbling air in a liquid phase for liquid extraction of a material; admixing material-binding agent with the inflowing air. Optionally, the material is as defined above.

Another object of the invention is to disclose, in a drying room as defined in any of the above, an air handling unit and one or more EC blowers are in provided fluid connection with the enveloping plenum; an air handling unit, configured to keep temperature and relative humidity steady within the inner drying volume, at levels of at least ±1.5° C. and ±5.5%, respectively.

Another object of the invention is to disclose, in a drying room as defined in any of the above, an air handling unit and one or more EC blowers are in provided fluid connection with the enveloping plenum, one or more EC blowers are configured, at 60% power, for facilitating (i) pressure of at least 150 Pascal and airflow velocity of at least 1.5 m/s at the exit of the planum] to within the room; and (ii) airflow velocity after the encounter of at least 0.24 m/s.

Another object of the invention is to disclose, in a drying room as defined in any of the above, a set of perforated walls, each of which comprises an array of open slots, each of which is characterized by a 120° angle on the plenum side of the wall and 110° on the room side.

Another object of the invention is to disclose, in a drying room as defined in any of the above, at least one module of NTP configured to kill at least two orders of magnitudes of molds during less than five minutes, by ionizing the airstream flowing within the plenum walls or ceiling.

Another object of the invention is to disclose an NTP system and modules thereof, configured to kill at least two orders of magnitudes of molds in a less than five minutes, by ionizing the airstream flowing within the plenum walls or ceiling; the NTP is provided a drying room for drying crops characterized by an efficiency index exceeding 35 kg/m² (kg of a wet crop per floor area), and by a plenum enveloping an inner drying volume, by means of a ceiling and a set of opposite perforated walls and comprising at least one of the following: (a) an air handling unit and one or more EC blowers are in provided fluid connection with the enveloping plenum; (b) an air handling unit, configured to keep temperature and relative humidity steady within the inner drying volume, at levels of at least ±1.5° C. and ±5.5%, respectively; (c) an air handling unit and one or more EC blowers are in provided fluid connection with the enveloping plenum, one or more EC blowers are configured, at 60% power, for facilitating (i) pressure of at least 150 Pascal and airflow velocity of at least 1.5 m/s at the exit of the planum to within the room; and (ii) airflow velocity after the encounter of at least 0.24 m/s; and (d) perforated walls comprises an array of open slots, each of which is are characterized by a 120° angle on the plenum side of the wall and 110° on the room side.

Another object of the invention is to disclose, in a drying room as defined in any of the above, an air handling unit and one or more EC blowers are in provided fluid connection with the enveloping plenum; at least one tray-rack module.

Another object of the invention is to disclose, a drying tray as defined in any of the above, wherein the drying tray comprises an array of ventilation slots in its walls and ventilation holes in its base, the ventilation holes provide between 45% to 75%, (e.g., 60%) of the perforated base area.

Another object of the invention is to disclose, in a drying room as defined in any of the above, a sensor for detecting at least one parameter selected from a group consisting of air temperature, humidity, wet-bulb temp., AH, relative humidity, crop's water activity, airflow speed, airflow direction, airflow volume, electrical conductivity, sound parameters (speed, pressure level, pitch, duration, loudness, timbre, and texture), parameters of light and electromagnetic radiation, including intensity, spectra, pulses' pattern, continuous wave patterns; additive concentration, weight, including time-resolved weight of the rack, the tray and dried crop, analytics, including chemical, microbial and biological detecting or measuring means, and any combination thereof. Another object of the invention is to disclose, in a drying room as defined in any of the above, a processor, provided in communication with the at least one sensor; the at least one of the four: a database, an air flow controller, the air handling unit and the EC blowers.

Another object of the invention is to disclose, in a drying room as defined in any of the above, a database stored in a retrievable manner in a computer-readable medium. The database comprises data selected from a group consisting drying room's parameters, including size, and shape; crop's related parameters, including crop type, its initial water content, required final water content, required temperature range, required humidity range, and required drying rate; outside parameters, including temperature and humidity; time-resolved stored drying room's parameters; parameter related with downstream processing, including drying, filtering, additives adding and NTP emitting parameters; time-resolved sensed, measured or otherwise detected data, and any combination thereof.

Another object of the invention is to disclose, in a drying room as defined in any of the above, a real-time feedback control mechanism for eliminating molds and plants pathogens; the feedback control mechanism is operatable in a method comprising steps of defining (101) and storing optimal parameters of a drying process for a given batch or batches of a crop; defining (102) and storing drying rate approved zone; measuring (103) predefined parameters in a continuous or intermittent manner, including weighing (104) dried crop along time; processing (105), by means of an airflow controller, parameters obtained in steps 103 and 104, thereby evaluating if drying rate is optimal, including evaluating if drying rate is either too fast (106) or too slow (107), as compared with drying rate approved zone (102). If drying rate is not optimal (108), redefining airflow parameters, including lowering air temperature, or decreasing airflow; otherwise, if drying rate is optimal, namely is within in a predefined approved zone, drying (109) the crop at same set of parameters until end of process.

Another object of the invention is to disclose, in a drying room as defined in any of the above, an NTP feedback mechanism operatable in a method comprising steps of defining (101) and storing optimal parameters of a drying process for a given batch or batches of a crop; measuring (103) predefined parameters in a continuous or intermittent manner, including weighing (104) dried crop along time; measuring total pathogens in the dried crops; if total pathogen concentration is greater than a predefined critical value, increasing (111) NTP performances or number of NTP modules.

Another object of the invention is to disclose, in a drying room as defined in any of the above, a feedback mechanism operatable in a method comprising both steps of, by means of the processor, the airflow controller, the air handling unit or the EC blowers, controlling crop temperature to a predefined temperature' allowed zone; by means of the processor, the an air flow controller, the air handling unit, the EC blowers, or downstream processing modules, controlling air parameters to a predefined allowed zone. Optionally, step of controlling air parameters is provided by means selected from a group consisting of adding to or enriching with at least one additive the drying air; drying the air; coalescent and conventional oil separating, liquid receiving and treating, eliminating pathogens by emitting NTP; filtering he air; contacting the air with a material-binding solid-phase or liquid-phase sorbents; bubbling air in a liquid phase for liquid extraction of a material; admixing material-binding agent with the inflowing air. Optionally, the material is as defined above.

Another object of the invention is to disclose drying room, modules, feedback mechanisms and methods as defined in any of the above, wherein the crop is selected from a plant grown to be harvested, post-harvested or used for any economic purpose, including agriculture crops, aquaculture crops, horticulture crops, floriculture crops, and industrial crops. Additionally, or alternatively, the crop is selected from a group consisting of crops intended for human or animal consumption, including human food and livestock fodder, for use as clothing, including fiber crops, for use as biofuel, including energy crops, algae fuel, for use in medicine, and for use as decorative, ornamental, or recreational plants, grain crops including cereals legumes, forage crops, fruits and vegetables, tree nuts, and oil, fat and wax crops, herbs and medicinal plants including vanilla pods, lavender, Cannabaceae plants, including Cannabis plants and hop plants.

### BRIEF DESCRIPTION OF THE FIGURES

The present invention will become more fully understood from the detailed description and the accompanying drawings, wherein

FIG. 1 illustrates a drying room according to an embodiment of the invention;

FIG. 2, schematically illustrates such a facilitated flow, in a drying room according to an embodiment of the invention;

FIGS. 3-5 schematically illustrate a front view of a perforated wall; a cross-section of the same, and a cross-section of one of the apertures with its two cutoff angles, respectively; according to some embodiments of the invention;

FIGS. 6a-d and 7 schematically illustrate weighing racks 60, 66, 68 and a double weighing rack construction 70, respectively, according to some embodiments of the invention;

FIGS. 8a-b schematically illustrate a rectangular drying tray, and a zoom-in view of the same, according to an embodiment of the invention;

FIG. 9 illustrates real-time monitoring of crops' moisture during a drying process in a drying room according to an embodiment of the present invention;

FIG. 10a illustrates in a simplified manner a flowchart of a drying process (100) with an airflow feedback mechanism, according to an embodiment of the invention. FIG. 10b similarly illustrates in a simplified manner a flow-chart of an NTP feedback mechanism in drying process (101) according to another embodiment of the invention; and

FIG. 11 shows use of NTP system for decontaminating human (oral) pathogens and repurposed here for decontamination of dried crops of its pathogens.

### DETAILED DESCRIPTION OF THE PREFERRED EMBODIMENTS

The present invention will now be described more fully hereinafter with reference to the accompanying drawings, in which a preferred embodiment of the invention is shown. This invention may, however, be embodied in many different forms and should not be construed as limited to the embodiments set forth herein; rather, this embodiment is provided so that this disclosure will be thorough and complete and will fully convey the scope of the invention to those skilled in the art.

As used herein, the term “drying room” refers to an area designed to maintain temperatures from +16° C. to '50° C., humidify to less than 1%, supply air dew points of at least −60° C., or any combination thereof. In some embodiments of the invention, the term also refers to HVAC systems, namely indoor enclosures with means for efficient heating (or colling), ventilating (or drying), and air conditioning.

The phrase “controlled temperature environment” as used herein refers to an environment created by enclosure in which a desired temperature is maintained by any method known in the art.

The term “crop” generally refers herein to any plant grown to be harvested, post-harvested or used for any economic purpose, including agriculture crops, aquaculture crops, horticulture crops, floriculture crops, and industrial crops. Non-limiting examples of crops include crops intended for human or animal consumption (e.g., human food and livestock fodder), for use as clothing (e.g., fiber crops), for use as biofuel (e.g., energy crops, algae fuel), for use in medicine, and for use as decorative, ornamental, or recreational plants. Non-limiting examples of crops intended for human or animal consumption include grain crops such as cereals (e.g., maize, rice, barley, oat, wheat, millet, sorghum, rye) and legumes (e.g., beans, peas, lentils, soybeans), forage crops, fruits and vegetables, tree nuts, and oil, fat and wax crops (e.g., oilseed crops such as canola, sunflower, coconut, palm, rapeseed, peanuts), herbs and medicinal plants such as vanilla pods, lavender, Cannabaceae plants, including Cannabis plants and hop plants.

The term “Cannabaceae plant” is used to include any member of the Cannabaceae family at any stage of development. A “Cannabaceae plant part” refers to any part of a Cannabaceae plant, including a plant cutting, a plant cell, a plant cell culture, a plant organ, a plant seed (achenes), and a plantlet. The family includes about 170 species grouped in about 11 genera, including economically important genera of Cannabis, Humulus lupulus and Celtis L. species.

The term “Cannabis plant” is used broadly to include a Cannabis sativa L. plant from any landrace, cultivar, or variety, at any stage of development. A Cannabis plant part refers to any part of a Cannabis plant, including a plant cutting, a plant cell, a plant cell culture, a plant organ, a plant seed (achenes), and a plantlet. C. sativa L. may be divided into three sub-species: C. sativa ssp. sativa, C. sativa ssp. indica, and C. sativa ssp. ruderalis. The term “hop plant” is used broadly to include plants of any species of Humulus lupulus from any landrace, cultivar, or variety, thereof, at any stage of development. A hop plant part refers to any part of a hop plant, including a plant cutting (e.g., rhizome), a plant cell, a plant cell culture, a plant organ (e.g., cones or hops), and a plantlet. Varieties of hop plants include hop plants cultivated for use in brewing (“Brewer's varieties) and ornamental varieties of Humulus lupulus. The term “Cannabis” is used herein to refer to all physiologically active substances derived from the Cannabis family of plants and synthetic Cannabis analogs and derivatives, precursors, metabolites etc., or related substances having Cannabis-like physiological effects, including cannabinoid and cannflavins.

The term “post-harvest” is the stage of crop production immediately following harvest, including cooling, cleaning, sorting and packing. The instant a crop is removed from the ground, or separated from its parent part, it begins to deteriorate. The term also refers to the point in time in which an agricultural commodity is harvested for sale, trade, or other human use. With respect to edible commodities e.g., fruit, vegetables, and fungi, or non-edible commodities that are picked, e.g., flowers, the commodity begins its existence as “postharvest” after picking. For non-edible commodities e.g., trees, shrubs, flowering plants, and/or seedling stocks, post-harvest is the point at which the commodity is packed, harvested, or otherwise prepared for marketing.

The term “plants” means all plants and plant populations, which include desirable and undesirable wild plants, cultivars, and plant varieties (whether or not protectable by plant variety or plant breeder's rights). Cultivars and plant varieties can be plants obtained by conventional propagation and breeding methods, which can be assisted or supplemented by one or more biotechnological methods such as by use of double haploids, protoplast fusion, random and directed mutagenesis, CRISPR/Cas, grafting, RNAi, molecular and/or genetic markers, and/or by bioengineering and genetic engineering methods. The term “plant parts” means all above ground and below ground parts and organs of plants such as shoot, leaf, blossom and root, whereby for example, leaves, needles, stems, branches, blossoms, fruiting bodies, fruits and seed as well as roots, corms and rhizomes are listed. Crops and vegetative and generative propagating material, for example cuttings, corms, rhizomes, runners, and seeds also belong to plant parts.

The term “laminar airflow” and “quasi-laminar airflow” as used herein, interchangeably refer to airflow in which the air flows in parallel layers with no disruption between the layers. In such laminar air flow, there are no cross-currents running directionally perpendicular to the airflow, nor are there incidents of turbulence, such as, by way of example only, eddies or swirls of air.

Laminar airflow, as referred to herein, refers to a non-turbulent flow of air, the direction of which is substantially parallel to a predetermined surface or direction.

As used herein, the term “about” refers to an amount that is near the stated amount by 10%, 5%, or 1%, including increments therein.

The present invention pertains, inter alia, to systems and methods for drying, sanitizing, moisture-controlling, and/or enhancing the potency of crops, e.g., by applying controlled air flow, temperature, and humidity regulation and providing real-time feedback control mechanisms, simultaneously eliminating molds and plants pathogens.

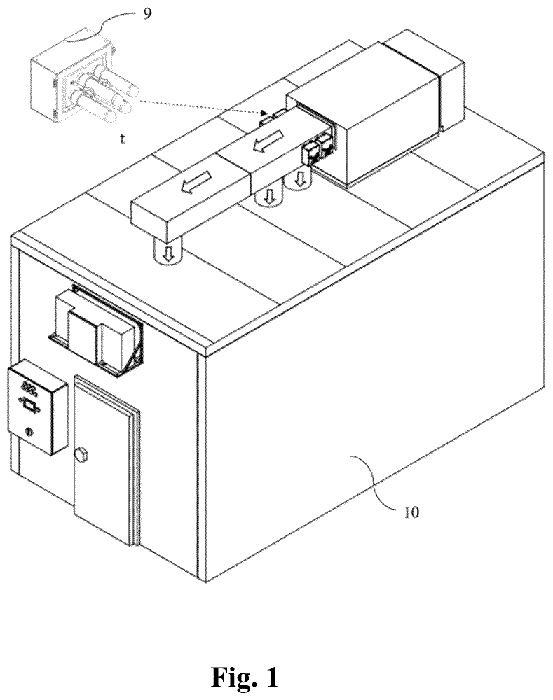

Reference is now made to FIGS. 1 to 8a, b, each of which schematically illustrates in a nonlimiting manner and in some cases, an out-of-scale manner one of a few embodiments of the invention: namely a perspective outside look at a drying room; a cross-section of an air (laminar-) flow within grooved walls of a drying room; front views of side walls of a drying room; front views of the top wall of a drying room; cross-section of the slots of the grooved walls of a drying room; a perspective view of a weighing rack reversibly accommodated with the drying room; a perspective view of a double-rack system for extra space utilization; and a perspective view of a drying tray accommodated within the weighing rack, correspondingly.

In conventional methods known in the art, Cannabis is dried by air dryers that flow moist air from the room over electric heaters which heat and dry the air. To help distribute the air in the room, fans are placed on the floor and walls. Air distribution by fans is limited in the ability to homogamically spread the air through the trays or hung branches. The result is “air-pockets” of uneven relative humidity and temperature. Therefore, a loss of flowers due to over/under drying is yielded. In addition, a large free space is required to surround the dried objects.

The drying room presented in FIGS. 1-8 (a, b) avoids aforesaid “air pockets” and facilitates effective and accurate measure (air volumes and flux), silent (with no air whistling) laminar, temperature controlled, pathogen-free and homogeneous air flow, adjacent and within all locations and portions of the drying trays.

It is in the scope of the invention wherein the effectivity of the hereto disclosed drying room and modules thereof is shown in a manner that a drying room of relatively small dimensions, e.g., width, length, and height of about 3.0×about 2.0 to about 60.0×3.6 meters, e.g., 3.0×8.0×3.6 meters, which is provided suitable for post-harvest processing of about 1,000 kg of wet crops, such as Cannabis flowers and trichomes thereof.

Referring again to FIGS. 1-8 (a, b) that disclose one set of embodiments of the invention, a drying room comprises inter alia a ceiling portion and at least two substantially vertical grooved side-walls (made of, e.g., stainless steel, polymers, etc.) mounted opposite each other. It is in the scope of the invention wherein a “plenum ceiling” and/or “plenum wall” is utilizable, namely at least one ceiling or wall portion provides a plenum space as a part of a drying room that can facilitate air circulation for heating and air conditioning systems, by providing pathways for either heated/conditioned or return airflows, usually at greater than atmospheric pressure.

The drying room further comprises or otherwise is provided in connection with an airflow controller, which is configured to online control physical air parameters, selected in a nonlimiting manner from a group consisting of air temperature, humidity (or, wet-bulb temp., Δ H, relative humidity), flow speed, flow direction, flow volume, light intensity, and other parameters, light and electromagnetic radiation (e.g., UV, IR, NIR, radiation's intensity, spectra, pulses, CW and any combination thereof) and any combination thereof.

An embodiment of the invention discloses that airflow controller controls or otherwise regulates airflow parameters by setting a specific and accurate airflow speed for each stage of the drying process. An air speed control is achievable by e.g., utilizing high-efficiency blowers that are EC-motors controlled with 0-10 VDC analog signal. The efficiency and accuracy of the EC motors allow high precision in the airflow regime control and energy saving.

Laminar or quasi-laminar air flow was demonstrated in the drying room of the present invention. Measurement of airflow velocity at the exit of the planum to the room with the blowers at 60% power was about 1.6 m/s. Airflow velocity after the encounter was about 0.25 m/s. Higher speeds than these cause damage to the inflorescences on the trays. The pressure inside the plenum at 60% Blower power was about 160 Pascal. The standard deviation in measuring various bank pressures in the room is about 5 Pascal.

According to other aspects of the invention, the controller is configured to online (or real-time) control chemical/biological air parameters, selected in a non-limiting manner form from a group consisting of powders, fluids, emulsions, pathogen concentration, additive(s) type, and concentration and any combination thereof. The term “additive” refers in a non-limiting manner to biocides and preservatives (e.g., metal salts, quaternary amine, bromomethane, ozone), plants hormones (e.g., ethylene and derivatives thereof, 1-methylcyclopropene), plants breeding agents and genetic materials, enzymes and coenzymes, plant extracts such as unsaponifiables, microorganisms such as probiotics, germination agents, fertilizes, acidulants and buffers, carbon dioxide, anti-caking agents, nitrogen gas, antifoaming agents, antioxidants, bulking agents, emulsifiers, flavor enhancers, perfuming agents, fruit and seed-coating agents, fertilizers, mineral salts, calcium carbonate containing dust, stabilizers, starches, thickeners, UV stabilizers, blockers or enhancers, vitamins and minerals and any combination, derivatives and mixtures thereof.

The hereto disclosed novel use of bromomethane in a drying room is provided useful in methods defined by Lazzeri, L., O. Leoni, and L. M. Manici. “Biocidal plant dried pellets for biofumigation.” Industrial crops and products 20.1(2004 ): 59-65. Similarly, the hereto disclosed novel use of ethylene is provided useful in methods defined by Pesis, Edna, et al. “Ethylene involvement in chilling injury symptoms of avocado during cold storage.” Postharvest Biology and Technology 24.2 (2002 ): 171-181. Further on, the hereto disclosed novel use of f 1-methylcyclopropene is provided useful in methods defined Porat, Ron, et al. “Effects of ethylene and 1-methylcyclopropene on the postharvest qualities of ‘Shamouti’ oranges.” Postharvest Biology and Technology 15.2 (1999 ): 155-163; all citations are incorporated herein as a reference.

In other sets of embodiments, air is forced to flow horizontally, in a laminar or quasi-laminar manner, form the walls, into the drying room, to the weighing racks (60) that are located adjacent to the walls. Each of the racks contains a plurality of perforated drying trays (63), each of the trays contains a crop to be dried. The trays are stacked upwardly in a vertical manner, having a predefined gap between each two neighboring trays. Flow control is achieved by continuously inflowing dry air in a horizontal manner, through apertures provided in the walls of the trays. Then, the hereto wetted air is further continuously outflow from the trays to the central portion of the drying room and flows vertically to be diverted in a plenum ceiling for further downstream processing.

Additionally, or alternatively, according to other sets of embodiments, air is forced to flow horizontally, in a laminar or quasi-laminar manner, form the walls, into the drying room, to the weighing racks (66) that are located adjacent to the walls. Each of the racks contain a plurality of perforated drying trellis (67), each of the trellis carries the crop to be dried. Flow control is achieved by continuously inflowing dry air in a horizontal manner, through the trellis provided in the walls of the trays. Then, the hereto wetted air is further continuously outflow from the trellis to the central portion of the drying room and flows vertically to be diverted in a plenum ceiling for further downstream processing.

Additionally, or alternatively, according to other sets of embodiments, air is forced to flow horizontally, in a laminar or quasi-laminar manner, form the walls, into the drying room, to the weighing racks (69) that are located adjacent to the walls. So, gaps between cassettes are in front of the vertical slots in the walls (plenum). Space between cassettes creates a flow path, from the plenum to the center of the room, and from there, air is vertically sucked to the ceiling, and to an air handling unit (AHU).

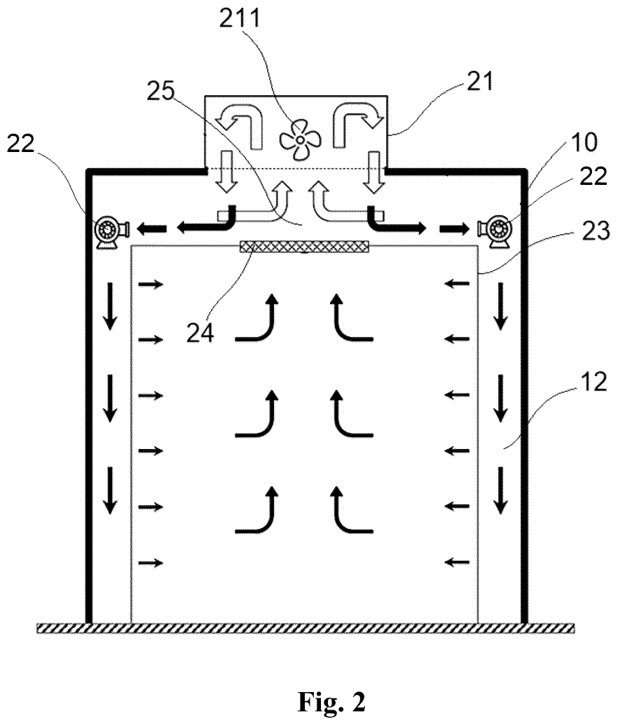

Reference is made again to FIG. 2, schematically illustrating such a facilitated flow, in a drying room 10 comprising e.g., air handling unit 21, EC blower 22, stainless steel perforated walls 23, filter 24, and plenum ceiling 25. Airflow is changed from substantiality horizontal to substantially vertical in the center portion of the room, i.e., where weighing racks (not shown here) is located. AHU 21 includes blower 211 and a dehumidifier (not shown). The water vapor condensed in the dehumidifier is removed from the air circulation circuit.

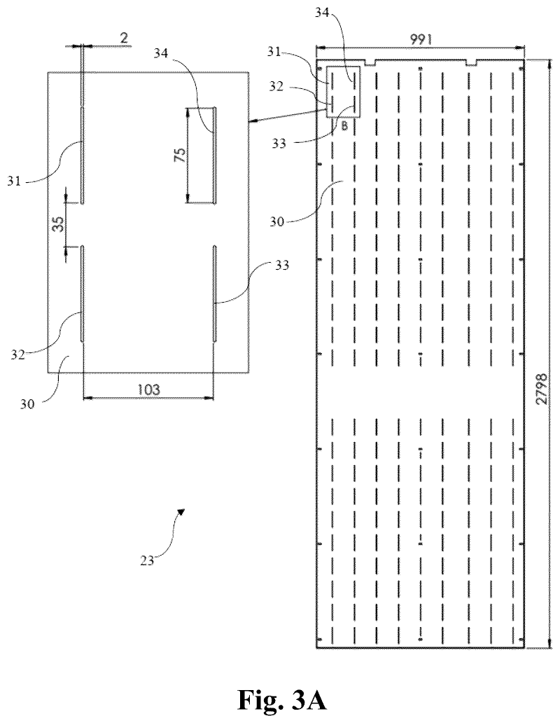

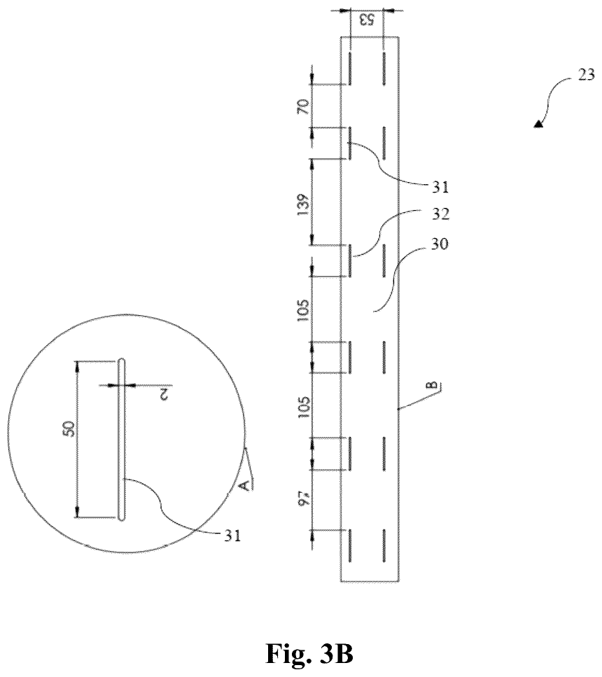

Reference is made again to FIGS. 3a-b, schematically illustrating a front view of a perforated ceiling portion 23 according to an embodiment of the invention. Dimensions (mm) are indicated as an example. Ceiling portion 23 is made as a continuous flat sheet of material, e.g., 336 Stainless-Steel, 30, which comprises an array of perforations 31, 32, 33, and 34.

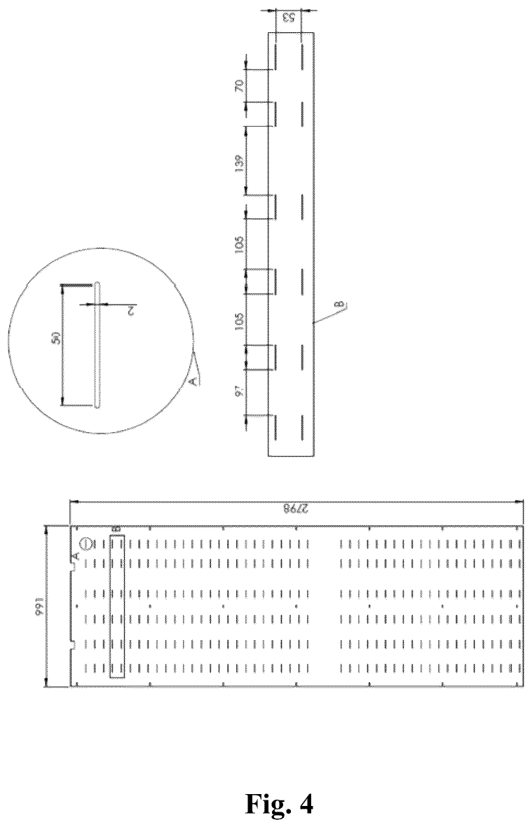

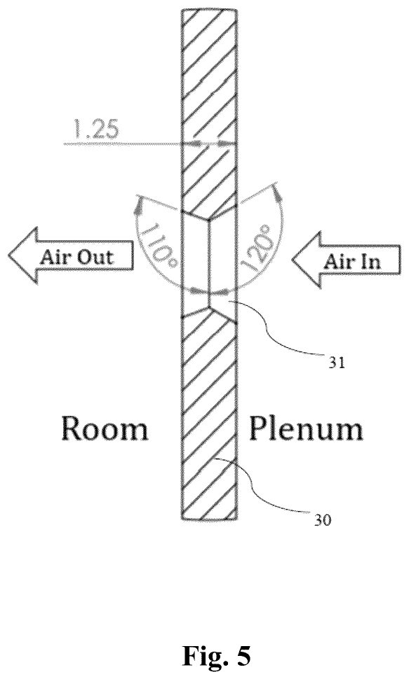

FIG. 4 schematically shows a cross-section of the wall, and FIG. 5 depicts a cross-section of one of the apertures (31) with its two cutoff angles: Slots designed with the specific 120° angle on the plenum side of the wall and 110° on the room side. This unique design was found to be to most efficient for airflow and avoiding “whistling” sound when using other angles.

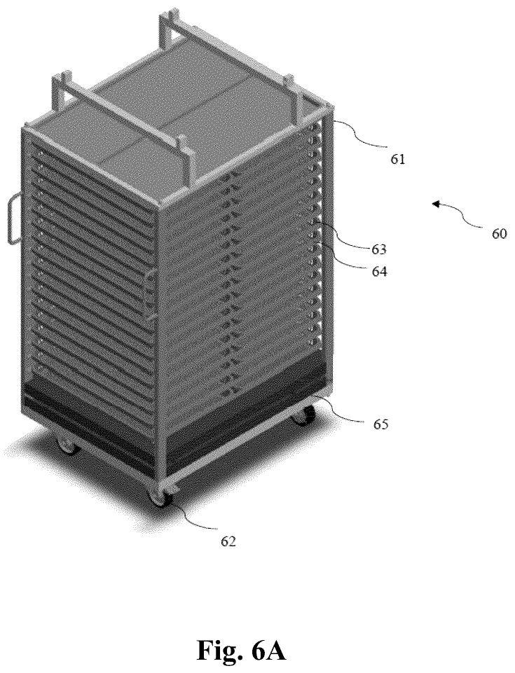

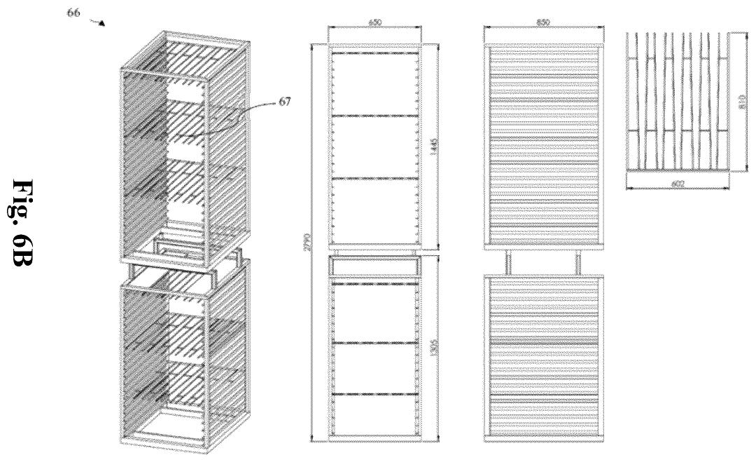

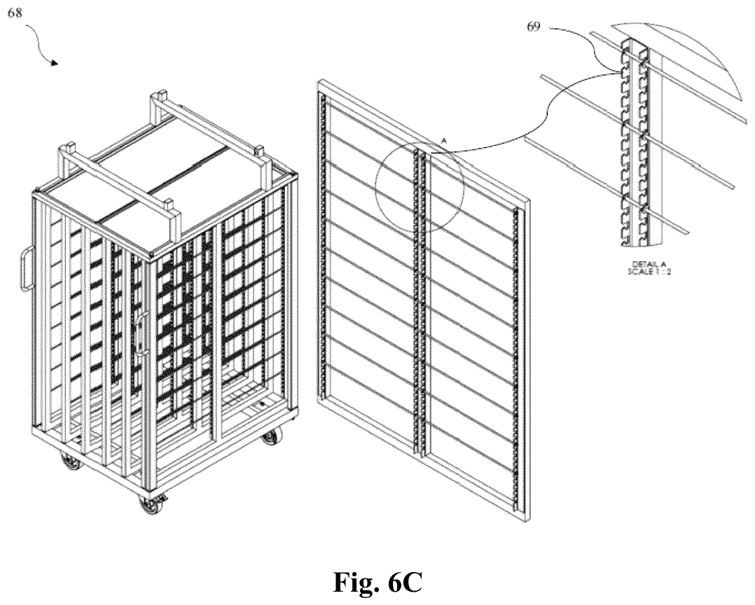

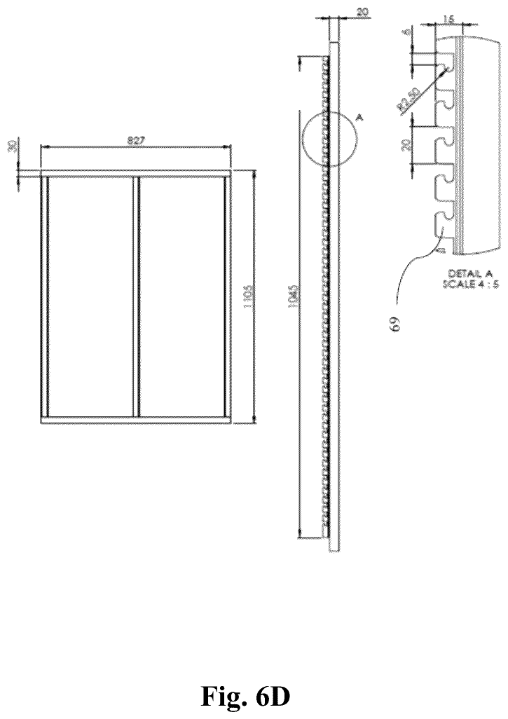

Reference is made again to FIGS. 6a-d and 7, schematically illustrating weighing racks 60, 66, 68, and a double weighing rack construction 70, respectively, according to yet another set of embodiments of the invention. Movable weighing rack 60 comprises a metal frame 61 with metal-made shelves-like construction, configured to carry a stack of parallelly set drying trays 63, 64. Movement is provided by any suitable means, such as wheels 62; use of rails; by means of automatic or semiautomatic robotic arms; using manually operated levers; providing autonomous pneumatic mechanism, or any combination thereof.

A double (or multiple-) weighing racks construction 70, comprises e.g., two or more weighing racks 60A-B; some of which comprise trays (60), some trellis (see trellis 67 in rack 66), and some that comprise hanging cassettes (see hanging-teeth 69 in rack 68). Optional dimensions are provided as an example.

Hanging buds for drying is a common method for drying Cannabis and other plants such as tobacco and others. The branches are hung on wires or poles which are installed at different levels on carts. One of the main weak points of this method is inconvenient access to branches that hung deep in the cart. It is also difficult to reach these branches in order to perform quality control tests during the drying process if required. These issues are solved by the concept of caste hanging. Hence, FIGS. 6c-d schematically depict in a non-limiting manner a cassette-type weighing rack 68 according to an embodiment of the invention, provided useful for drying Cannabis and other crops. This construction is based on independent stainless-steel frames that have slots (hereinafter-“teeth” 69) along both sides of the frame, positioned in the vertical dimension. Rods are placed on these slots, so that spacing between the rods is easily changed according to size of the branches. The frames are placed on a dedicated dollie, e.g., a heavy-duty wheeled platform. Access to any part of the frame is easy and simple from both sides. When the hanging of the buds is finished, a dollie is brought closer to a drying cart that has suitable rails on it so that the cassette with the branches is easily pushed onto these rails. When the cart is full, it is placed in the drying room, so gaps between the cassettes is in front of the vertical slots in the walls (plenum). Space between cassettes creates a flow path, from the plenum to the center of the room, and from there, air is vertically sucked to the ceiling, and to an air handling unit (AHU).

Another advantage of the controlled flow of slotted air nozzles is to reduce the air gap between trays to a minimum. This is key feature that makes the hereto disclosed drying room 10 highly efficient: A common index in the art for evaluation of floor and space utilization (hence the efficiency) of a drying room is kg of flowers per floor area (kg/m²). The drying room of the present invention is characterized by an index of about 35.5 kg/m² . This high level of utilization index is due to three key elements: tight and precise air gap optimization; AHU (Air Handling Unit) designed to support such tight and accurate air gaps and supply a laminar flow rate that removes moisture and controls temperature; and potentially, a built-in electric forklift, configured to loads two or more drying racks on each other and occupies a small floor space by itself.

It is in the scope of the invention wherein the weighing rack is of known self-weight (tare weight) and the drying process comprising one or more steps of offline or batchwise weighing the rack along a relevant time frame to measure crop dryness. Additionally, or alternatively, a weighing rack 65 hereto disclosed comprises, or otherwise provided in connection, with an electronic scale, which measures the weight of the rack along a relevant time frame, in either a continuous manner or at retrievable intervals of time. The net weight of the crops on trays is hence calculated, and potentially further processed by the aforesaid air flow controller, to optimize the drying process along time, namely along the crops' process of drying, hence loss of weight.

Additionally, or alternatively, the weighing rack comprises or otherwise is provided in connection with other means for determining water content in dried crops, including utilizing Karl Fischer titrators, measuring electrical conductivity, applying spectral methods and other means disclosed in the literature; See Pande, Anurag. Handbook of moisture determination and control. Principles, techniques, applications. Vol. 3. Marcel Dekker, Inc., 1975, and Park, Young W. “Moisture and water activity.” Handbook of processed meats and poultry analysis. CRC Press, 2008. pp. 45-65, both are incorporated herein as a reference.

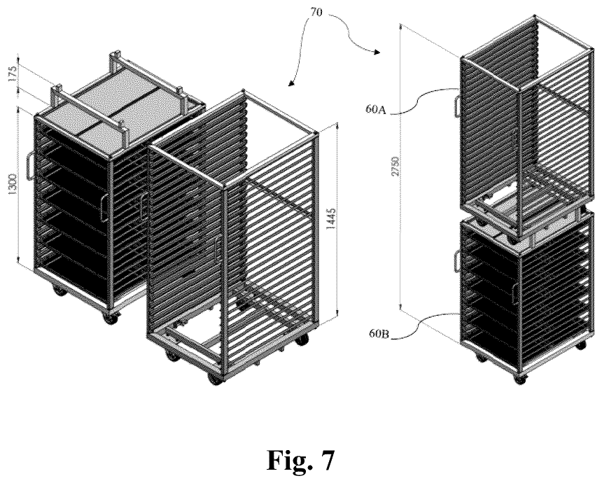

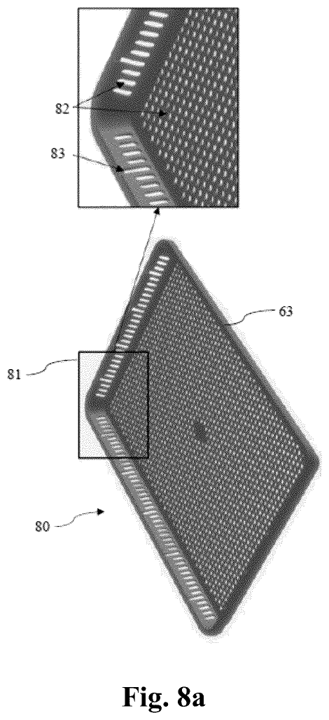

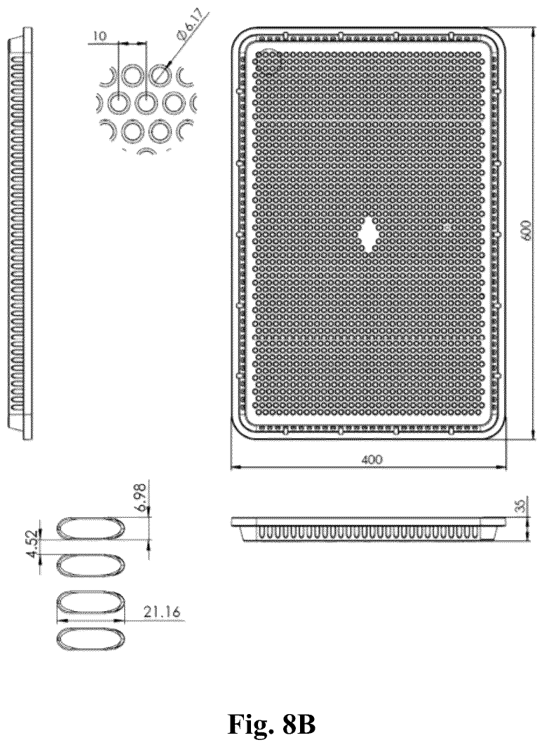

Reference is made again to FIG. 8a-b, schematically illustrating a rectangular (80) drying tray 63, and a zoom-in view 81 of the same. comprises. The tray comprises perforated bottom and wall portions, characterized by an array of perforations 82 and water drainers 83. In an embodiment of the invention, a dedicated plastic tray is used and configured to be compatible with the racks system and the grooved walls. As an example, a drying tray is characterized by being lightweight 600 gr; constructed by Food and drugs plastic grade; Ventilation slots in the walls and ventilation holes in the base, allow moisture removal from the flowers; Enlarged grooves on the walls to prevent the accumulation of liquids when cleaning trays between drying cycles; and “Nesting” (trays fits into each other) to save space when in storage.

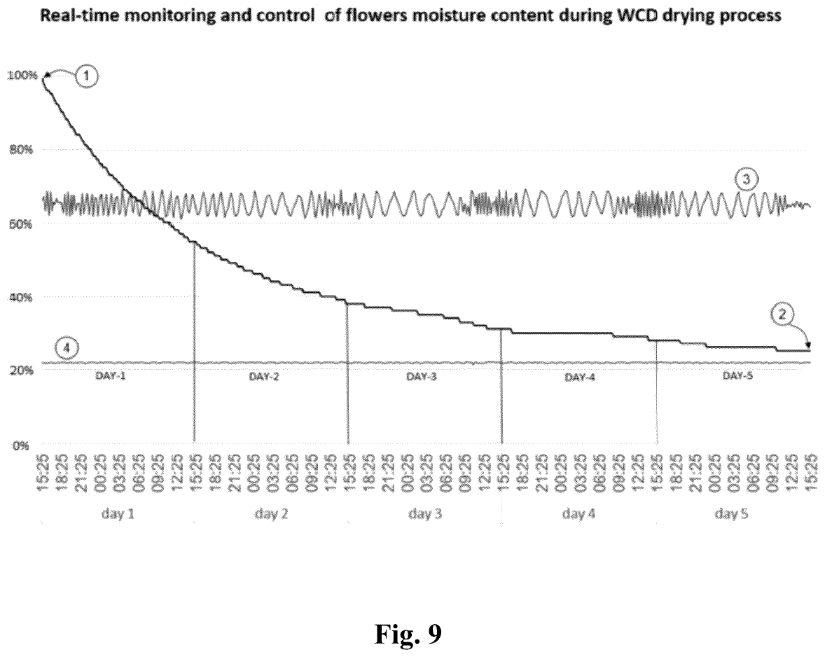

Reference is now made to FIG. 9 illustrating real-time monitoring of crops' moisture during a drying process in a drying room according to an embodiment of the present invention. Y-axis defined water content (% wt.) in the crop along the drying process. X-axis defines the time of the process. Here the process is optimized for drying about 1 ton of Cannabis in drying room 10 for 5 days, from 100% (1) water content to the required water content of about 23% (2). About 75% of the water was dried along during the first two days (4) and the rest 25% during the following three days. In this experiment, and along the entire five-day process, airflow parameters, including temperature, humidity, and velocity, were kept steady, at remarkable accuracy levels of ±1° C. and ±5% (3), for air temperature and relative humidity, respectively.

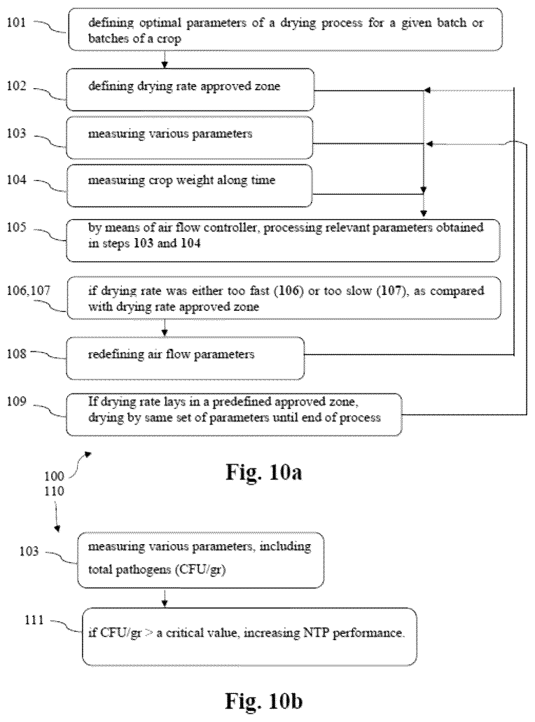

Reference is now made to FIG. 10a, illustrating in a simplified manner a flow-chart of a drying process (100) with an air flow feedback mechanism, according to an embodiment of the invention. The first step (101) defines the optimal parameters of a drying process for a given batch or batches of a crop. The data is stored in a retrievable manner in a computer-readable medium. Likewise, (102), the drying rate approved zone is defined.

In one or more sets of steps (103), various parameters are continuously or intermittently (e.g., periodically or by achieving a milestone of the process) measured, including, e.g., parameters selected from a group consisting of room's parameters (size, shape, etc. ,); crop's related parameters (including crop type, its initial water content, required final water content, required temperature range, humidity range, and drying rate); outside (-ambient) temperature and humidity; drying room's temperature and humidity; airflow parameters, including air temperature, humidity, flow-speed, flow direction, flow volume; when applicable: light and electromagnetic radiation (including UV, IR, NIR, radiation's intensity, spectra, pulses parameters, continuous wave parameters and any combination thereof) and any combination thereof; additives addition rate and any combination thereof.

As the process progresses, the weight of the flowers decreases due to liquid removal. For monitoring, we perform real-time weighing of the flowers throughout the process and display the data on a dynamic graph. According to the graph data, the operator can see the drying rate and decide which parameters to adjust. Once a desired process has been achieved, it will be saved and established as a protocol for future drying cycles.

At other one or more sets of steps (104), the crop weight is continuously or intermittently measured.

Then, in one or more steps 105, is by means of an airflow controller, continuously or intermittently processing relevant parameters obtained in steps 103 and 104 thereby evaluating if the drying rate was either too fast (106) or too slow (107), as compared with drying rate approved zone. Then (108), redefining air flow parameters (e.g., lowering air temperature, and/or decreasing airflow). If the drying rate is in a predefined approved zone, drying at same set of parameters is maintained until end of process (109).

Harvested crops comprise plants pathogens, some of which originate from the field, others are accumulated along the post-harvesting processes. Moreover, senescence happens during all growing cycles, and then ultimately leads to plants' death. In Cannabis plants, plants' death plays an essential role in diverse physiological actions, including root cap, stomatic embryogenesis, xylogenesis, leaf senescence and defense against microbial pathogens and abiotic stresses. Hence, post harvesting processes, including drying plants' organs require effective biocidal means, some are time-resolved means, as the crop changes its nature along process, so that pathogens may vary along processing time.

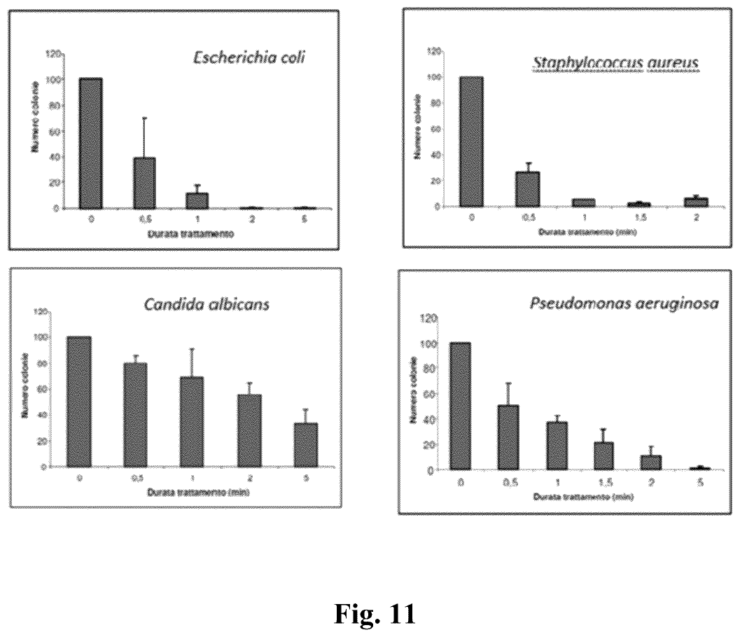

A use of NTP, namely means and methods for electrically energizing and/or ionizing matter in a gaseous state, for decontaminating dried crops of its pathogens is hereto disclosed. NTP was found extremely effective in decontamination of Staphylococcus aureus, Pseudomonas aeruginosa, Escherichia coli and Candida albicans, see FIG. 11, and others, such as Aspergillus brasiliensis, Salmonella, Legionella, COVID-19, molds etc. Some relevant data is derived from currently available link: https://www.vsdental.it/uploads/attachment/attachment/433/DOSSIER_scientifico%20JONX_R.03.pdf.

An NTP (9, FIG. 1) was found effective to kill molds in a few minutes by ionizing the air, without adding any additional chemicals. It is acknowledged that the number of NTP units (or their output) is proportional to the room size. Unlike other anti-molds treatments such as UV, in which molds will only be affected if they pass in proximity to the UV bulb, the hereto presented NTP system blows ionized air into the room, creates an atmosphere which neutralizes existing molds and prevents development of new ones. Commercially available NTP and NTPlike means, are commercially available, including, e.g., DUCT™ 70MIC4C product, by Jonix S.p.A. B Corporation (Italy) and Sterionizer™ D6 by FILT AIR Ltd (Israel).

Reference is now made to FIG. 10b, illustrating in a simplified manner a flow-chart of an NTP feedback mechanism in drying process (101) according to an embodiment of the invention. In this method, there is provided step 103 as defined above, for measuring various parameters, and the step further comprising comprises measuring total pathogens in the dried crop (CFU/gr). If total pathogen concentration (CFU/gr) is greater than a predefined critical value, the system is operatable for (111) increasing NTP performance. Hence, the feedback mechanism provided useful in the drying room of the present invention, further comprises increase NTP activation when the pathogen exceeds the predefined (allowed, approved) value.

It is further in the scope of the invention wherein additives are admixed with the drying air to regulate crops' content. Most growers and commercial processors predicate the product is dry based on texture and crispness, while having only 11% w/w of moisture. Any change in drying conditions may cause decarboxylation of acidic cannabinoids, loss of terpenes and reduced product quality Hence for example, during storage, mostly over 24 h, cannabichromene (CBN) is formed by the decarboxylation of Δ9-tetrahydrocannabin (THC) at temperatures over 50° C.; and cannabidiol (CBD) is at risk of oxidative degradation, see Ubeed, et al., “Post-Harvest Operations to Generate High-Quality Medicinal Cannabis Products: A Systemic Review.” Molecules 27.5 (2022).

The drying room and modules thereof disclosed here allows heating the Cannabis plant to 37° C.±1° C. hence prevent decarboxylation for Phyto cannabinoids.

Similarly, as oxidation occurs with light, heat, and oxygen, degradation of major cannabinoids is minimized after drying by storage in dark and oxygen-free places. The drying room and modules thereof disclosed here allow to dry Cannabis plants in a dark and oxygen-reduce atmosphere, by either or both immobilizing oxygen outflow by (i) oxygen-binding solid-phase sorbents; (ii) reversible liquid extraction of the oxygen (iii) admixing oxygen-binding agent with the inflowing air; and simply by (iv) enriching the inflowing air with nitrogen.

In the specification, there have been disclosed typical preferred embodiments of the disclosure and, although specific terms are employed, they are used in a generic and descriptive sense only and not for purposes of limitation. Some typical embodiments of the disclosure have been described. Many more examples, modifications, and variations of the disclosure are possible in light of the above teachings. For instance, although the disclosure and the claims indicate specific steps to perform the invention, the steps described are not limited to a particular sequence of performance and in some circumstances two or more of these steps could be undertaken simultaneously. It is therefore to be understood that within the scope of the appended claims the disclosure may be practiced otherwise than as specifically described, and the scope of the disclosure is set out in the claims.

1.-49. (canceled)

50. A room for drying crops characterized by a closed plenum enveloping an inner drying volume, by means of a ceiling and a set of opposite perforated walls; an air handling unit and one or more EC blowers are in provided fluid connection with said closed enveloping plenum; said drying room is further characterized by:
a. said air handling unit is configured to keep temperature and relative humidity steady within said inner drying volume, at levels of at least ±1.5° C. and ±5.5%, respectively;
b. said one or more EC blowers are configured, at 60% power, for facilitating:
i. pressure of at least 150 Pascal and airflow velocity of at least 1.5 m/s at the exit of said plenum to within said room; and
ii. airflow velocity after said encounter of at least 0.24 m/s; and
c. said perforated walls comprise an array of open slots, each of which is characterized by a 120° angle on said plenum side of said wall and 110° on said room side.

51. The drying room of claim 50, wherein at least one of the following is held true:
a. said room further characterized by at least one module of NTP configured to kill at least two orders of magnitudes of molds in less than five minutes, by ionizing said airstream flowing within said plenum walls or ceiling.
b. a rack 60 further comprising at least one drying tray 63, configured by shape and size to be accommodated within said tray-rack;
c. a rack 66 further comprising at least one trellis 67, configured by shape and size to be accommodated within said rack; and
d. a rack 68 further comprising one or more hanging slots or hanging teeth, configured by shape and size to be accommodated within said rack;
e. said drying tray comprises an array of ventilation slots in its walls and ventilation holes in its base, said ventilation holes provide between 45% to 75%, of said perforated base area.

52. The drying room of claim 50, said inner volume comprises at least one tray-rack, accommodating a vertical stack of drying trays; wherein of the following is held true:
a. air is forced to flow horizontally, in a laminar or quasi-laminar manner, form from said walls, into said drying room, to weighing racks (60) that are located adjacent to said walls; each of said racks contains a plurality of perforated drying trays (63), each of said trays contains crop to be dried; said trays are stacked upwardly in a vertical manner, having a predefined gap between each two neighboring trays; flow control is achieved by continuously inflowing dry air in a horizontal manner, through apertures provided in said walls of said trays; then, hereto wetted air is further continuously outflow from said trays to said central portion of said drying room, and flow vertically to be diverted in a plenum ceiling for further downstream processing; and
b. air is forced to flow horizontally, in a laminar or quasi-laminar manner, from said walls, into said drying room, to said weighing racks (66) that are located adjacent to said walls; each of said racks contains a plurality of perforated drying trellis (67), each of said trellis caries crop to be dried; flow control is achieved by continuously inflowing dry air in a horizontal manner, through said trellis provided in said walls of said trays; then, hereto wetted air is further continuously outflow from said trellis to said central portion of said drying room, and flow vertically to be diverted in a plenum ceiling for further downstream processing;
c. air is forced to flow horizontally, in a laminar or quasi-laminar manner, from the walls, into the drying room, to the weighing racks (69) that are located adjacent to the walls, so gaps between cassettes are in front of the vertical slots in the walls (plenum), space between cassettes creates a flow path, from the plenum to the center of the room, and from there air is vertically sucked to the ceiling, and to an AHU.

53. The drying room according claim 50, further comprising at least one of the following:
a. at least one sensor for detecting at least one parameter selected from the group consisting of air temperature, humidity, wet-bulb temp., AH, relative humidity, crop's water activity, airflow speed, airflow direction, airflow volume, electrical conductivity, sound parameters (speed, pressure level, pitch, duration, loudness, timbre, and texture), parameters of light and electromagnetic radiation, including intensity, spectra, pulses' pattern, continuous wave patterns; additive concentration, weight, including time-resolved weight of said rack, said tray and dried crop, analytics, including chemical, microbial and biological detecting or measuring means, and any combination thereof; and
b. a processor, in communication with said at least one sensor; said at least one of the four: a database, an airflow controller, said air handling unit, and said EC blowers; optionally, said database is stored in a retrievable manner in a computer-readable medium, said database comprises data selected from the group consisting drying room's parameters, including size, and shape; crop's related parameters, including crop type, its initial water content, required final water content, required temperature range, required humidity range, and required drying rate; outside parameters, including temperature and humidity; time-resolved stored drying room's parameters; parameter related with downstream processing, including drying, filtering, additives adding and NTP emitting parameters; time-resolved sensed, measured or otherwise detected data, and any combination thereof.

54. The drying room of claim 50, wherein at least one of the following is held true:
a. said drying room is useful for drying, sanitizing, moisture-controlling, and/or enhancing potency of crops, by applying controlled air flow, temperature, and humidity regulation and providing real-time feedback control mechanisms, simultaneously eliminating molds and plants pathogens; said feedback control mechanism is operable in a method comprising steps of
i. defining (101) and storing optimal parameters of a drying process for a given batch or batches of a crop;
ii. defining (102) and storing drying rate approved zone;
iii. measuring (103) predefined parameters in a continuous or intermittent manner, including weighing (104) dried crop over time;
iv. processing (105), by means of an airflow controller, parameters obtained in steps 103 and 104, thereby evaluating if drying rate is optimal, including evaluating if drying rate is either too fast (106) or too slow (107), as compared with drying rate approved zone (102);
v. if drying rate is not optimal (108), redefining airflow parameters, including lowering air temperature, or decreasing airflow; otherwise,
vi. if drying rate is optimal, namely is within a predefined approved zone, drying (109) said crop at same set of parameters until end of process; and
b. said drying room is useful for killing crop's pathogens by ionizing said recycled air characterized by an NTP feedback mechanism operable in a method comprising steps of
i. defining (101) and storing optimal parameters of a drying process for a given batch or batches of a crop;
ii. measuring (103) predefined parameters in a continuous or intermittent manner, including weighing (104) dried crop over time;
iii. measuring total pathogens in said dried crop; and
iv. if total pathogen concentration is greater than a predefined critical value, increasing (111) NTP performances or number of NTP modules;
c. said drying room is useful for regulating crops' specification and maximizing its market value, characterized by a feedback mechanism operable in a method comprising both steps of
i. by means of said processor, said an airflow controller, said air handling unit or said EC blowers, controlling crop temperature to a predefined temperature' allowed zone;
ii. by means of said processor, said an airflow controller, said air handling unit, said EC blowers, or downstream processing modules, controlling air parameters to a predefined allowed zone;
optionally, said step of controlling air parameters is provided by means selected from the group consisting of adding to or enriching with at least one additive said drying air; drying said air; coalescent and conventional oil separating, liquid receiving and treating, eliminating pathogens by emitting NTP; filtering the air; contacting said air with a material-binding solid-phase or liquid-phase sorbents; bubbling air in a liquid phase for liquid extraction of a material; admixing material-binding agent with said inflowing air.

55. A method of drying comprising steps of
a. enveloping an inner drying volume with a close plenum of a ceiling and a set of opposite perforated walls; providing an air handling unit and one or more EC blowers in a fluid connection with said enveloping plenum;
b. configuring said air handling unit to keep temperature and relative humidity steady within said inner drying volume, at levels of at least ±1.5° C. and ±5.5%, respectively;
c. configuring said one or more EC blowers, at 60% power, for facilitating
i. pressure of at least 150 Pascal and airflow velocity of at least 1.5 m/s at said exit of said plenum to within said room; and
ii. airflow velocity after said encounter of at least 0.24 m/s; and
d. providing said perforated walls with an array of open slots, each of which is characterized by a 120° angle on said plenum side of said wall and 110° on said room side;
optionally, said method comprises step of providing said drying room with at least one module of NTP configured to kill at least two orders of magnitudes of molds in less than five minutes, by ionizing said airstream flowing within said plenum walls or ceiling;
further optionally, said method comprises a step of providing said drying tray with an array of ventilation slots in its walls and ventilation holes in its base, in a measure that said ventilation holes provide between 45% to 75%, of said perforated base area.

56. The method of claim 55, wherein at least one of the following is held true:
a. said method comprising steps of forcing air to flow horizontally, in a laminar or quasi-laminar manner, form said walls, into said drying room, to one or more weighing racks (60) that are located adjacent to said walls; providing each of said racks to contain a plurality of perforated drying trays (63), each of said trays contains crop to be dried; providing said trays are stacked upwardly in a vertical manner, having a predefined gap between each two neighboring trays; providing a flow control by continuously inflowing dry air in a horizontal manner, through apertures provided in said walls of said trays; then, hereto wetted air is continuously outflowing from said trays to said central portion of said drying room, and then flowing vertically to be diverted in a plenum ceiling for further downstream processing;
b. said method comprising steps of forcing air to flow horizontally, in a laminar or quasi-laminar manner, form said walls, into said drying room, one or more weighing racks (66) that are located adjacent to said walls; providing each of said racks to contain a plurality of perforated drying trellis (67), each of said trellis caries crop to be dried; providing flow control by continuously inflowing dry air in a horizontal manner, through trellis provided in said walls of said trays; then hereto wetted air is further continuously outflowing from said trellis to said central portion of said drying room, and then flowing vertically to be diverted in a plenum ceiling for further downstream processing; and
c. said method comprising steps of forcing air to flow horizontally, in a laminar or quasi-laminar manner, form said walls, into said drying room, to one or more weighing racks (69) that are located adjacent to said walls, so gaps between cassettes is in front of the vertical slots in said walls (plenum); space between cassettes creates a flow path, from said plenum to center of said room, and from there air is vertically sucked to said ceiling, and to an AHU;
d. said method further comprising a step of providing at least one sensor for detecting at least one parameter selected from the group consisting of air temperature, humidity, wet-bulb temp., AH, relative humidity, crop's water activity, airflow speed, airflow direction, airflow volume, electrical conductivity, sound parameters, including speed, pressure level, pitch, duration, loudness, timbre and texture, parameters of light and electromagnetic radiation, including intensity, spectra, pulses' pattern, continuous wave patterns; additive concentration, weight, including time-resolved weight of said rack, said tray and dried crop, analytics, including chemical, microbial and biological detecting or measuring means, and any combination thereof;
e. said method further comprising a step of communicating a processor with said at least one sensor and with said at least one of the four: a database, an airflow controller, said air handling unit, and said EC blowers.

57. The method of claim 55, useful for drying, sanitizing, moisture-controlling, and/or enhancing potency of crops, by applying controlled air flow, temperature, and humidity regulation and providing real-time feedback control mechanisms, simultaneously eliminating molds and plants pathogens; said feedback control mechanism is operable by steps of:
a. defining (101) and storing optimal parameters of a drying process for a given batch or batches of a crop;
b. defining (102) and storing drying rate approved zone;
c. measuring (103) predefined parameters in a continuous or intermittent manner, including weighing (104) dried crop over time;
d. processing (105), by means of an airflow controller, parameters obtained in steps 103 and 104, thereby evaluating if drying rate is optimal, including evaluating if drying rate is either too fast (106) or too slow (107), as compared with drying rate approved zone (102);
e. if drying rate is not optimal (108), redefining airflow parameters, including lowering air temperature, or decreasing airflow; otherwise,
f. if drying rate is optimal, namely is within a predefined approved zone, drying (109) said crop at same set of parameters until end of process.

58. The method of claim 57 utilized for killing crop's pathogens by ionizing said recycled air characterized by an NTP feedback mechanism operable by steps of
a. defining (101) and storing optimal parameters of a drying process for a given batch or batches of a crop;
b. measuring (103) predefined parameters in a continuous or intermittent manner, including weighing (104) dried crop over time;
c. measuring total pathogens in said dried crop;
d. if total pathogen concentration is greater than a predefined critical value, increasing (111) NTP performances or number of NTP modules.

59. The method of claim 57, utilized for regulating crops' specification and maximizing its market value, characterized by a feedback mechanism operable in a method comprising both steps of
a. by means of said processor, said airflow controller, said air handling unit, or said EC blowers, controlling crop temperature to a predefined temperature' allowed zone; and
b. by means of said processor, said airflow controller, said air handling unit, said EC blowers, or downstream processing modules, controlling air parameters to a predefined allowed zone;
c. optionally, said step of controlling air parameters is provided by means selected from the group consisting of adding to or enriching with at least one additive said drying air; drying said air; coalescent and conventional oil separating, liquid receiving and treating, eliminating pathogens by emitting NTP; filtering the air; contacting said air with a material-binding solid-phase or liquid-phase sorbents; bubbling air in a liquid phase for liquid extraction of a material; admixing material-binding agent with said inflowing air.

60. In a drying room as defined in claim 50, an air handling unit and one or more EC blowers are in provided fluid connection with said enveloping plenum; an air handling unit, configured to keep temperature and relative humidity steady within said inner drying volume, at levels of at least ±1.5° C. and ±5.5%, respectively; optionally, an air handling unit and one or more EC blowers are in provided fluid connection with said enveloping plenum, one or more EC blowers are configured, at 60% power, for facilitating (i) pressure of at least 150 Pascal and airflow velocity of at least 1.5 m/s at said exit of said planum to within said room; and (ii) airflow velocity after said encounter of at least 0.24 m/s; further optionally, perforated walls each of which comprises an array of open slots, each of which is characterized by a 120° angle on said plenum side of said wall and 110° on said room side.

61. An NTP configured to kill at least two orders of magnitudes of molds in less than five minutes, by ionizing said airstream flowing within said plenum walls or ceiling; said NTP is provided a drying room for drying crops characterized by an efficiency index exceeding 35 kg/m² (kg of a wet crop per floor area), and by a plenum enveloping an inner drying volume, by means of a ceiling and a set of opposite perforated walls and comprising at least one of said following:
a. an air handling unit and one or more EC blowers are in provided fluid connection with said enveloping plenum;
b. an air handling unit, configured to keep temperature and relative humidity steady within said inner drying volume, at levels of at least ±1.5° C. and ±5.5%, respectively;
c. an air handling unit and one or more EC blowers are in provided fluid connection with said enveloping plenum, one or more EC blowers are configured, at 60% power, for facilitating
i. pressure of at least 150 Pascal and airflow velocity of at least 1.5 m/s at said exit of said plenum to within said room; and
ii. airflow velocity after said encounter of at least 0.24 m/s; and
d. perforated walls comprise an array of open slots, each of which is characterized by a 120° angle on said plenum side of said wall and 110° on said room side.

62. In a drying room as defined in claim 50, a weighing rack, wherein at least one of the following is held true:
a. a weighing rack 60 comprises a metal frame 61 with metal-made shelves-like construction, configured to carry a stack of parallel set drying trays 63, 64;
b. a weighing rack 66 comprises a metal frame 61 with one or more metal-made trellis 67; and,
c. a weighing rack 68 comprises a metal frame 61 with one or more metal-made slots or teeth 67;
optionally, said drying tray comprises an array of ventilation slots in its walls and ventilation holes in its base, said ventilation holes provides between 45% to 75% of said perforated base area.

63. The drying room of claim 62, wherein said room further comprising at least one of the following:
a. a sensor for detecting at least one parameter selected from the group consisting of air temperature, humidity, wet-bulb temp., AH, relative humidity, crop's water activity airflow speed, airflow direction, airflow volume, electrical conductivity, sound parameters (speed, pressure level, pitch, duration, loudness, timbre, and texture), parameters of light and electromagnetic radiation, including intensity, spectra, pulses' pattern, continuous wave patterns; additive concentration, weight, including time-resolved weight of said rack, said tray and dried crop, analytics, including chemical, microbial and biological detecting or measuring means, and any combination thereof;
b. a processor, provided in communication with said at least one sensor; said at least one of said four: a database, an airflow controller, said air handling unit and said EC blowers; and
c. a database, stored in a retrievable manner in a computer-readable medium, said database comprises data selected from the group consisting drying room's parameters, including size, and shape; crop's related parameters, including crop type, its initial water content, required final water content, required temperature range, required humidity range, and required drying rate; outside parameters, including temperature and humidity; time-resolved stored drying room's parameters; parameter related with downstream processing, including drying, filtering, additives adding and NTP emitting parameters; time-resolved sensed, measured or otherwise detected data, and any combination thereof.

64. In a drying room in claim 50, a real-time feedback control mechanism for eliminating molds and plants pathogens; said feedback control mechanism is operable in a method comprising steps of
a. defining (101) and storing optimal parameters of a drying process for a given batch or batches of a crop;
b. defining (102) and storing drying rate approved zone;
c. measuring (103) predefined parameters in a continuous or intermittent manner, including weighing (104) dried crop over time;
d. processing (105), by means of an airflow controller, parameters obtained in steps 103 and 104, thereby evaluating if drying rate is optimal, including evaluating if drying rate is either too fast (106) or too slow (107), as compared with drying rate approved zone (102);
e. if drying rate is not optimal (108), redefining airflow parameters, including lowering air temperature, or decreasing airflow; otherwise,
f. if drying rate is optimal, namely is within a predefined approved zone, drying (109) said crop at same set of parameters until end of process.

65. In a drying room of claim 50; an NTP feedback mechanism operable in a method comprising steps of
a. defining (101) and storing optimal parameters of a drying process for a given batch or batches of a crop;
b. measuring (103) predefined parameters in a continuous or intermittent manner, including weighing (104) dried crop over time;
c. measuring total pathogens in said dried crop;
d. if total pathogen concentration is greater than a predefined critical value, increasing (111) NTP performances or number of NTP modules.

66. In a drying room of claim 50, a feedback mechanism operable in a method comprising both steps of
a. by means of said processor, said an airflow controller, said air handling unit, or said EC blowers, controlling crop temperature to a predefined temperature' allowed zone;
b. by means of said processor, said an airflow controller, said air handling unit, said EC blowers, or downstream processing modules, controlling air parameters to a predefined allowed zone;
wherein said step of controlling air parameters is provided by means selected from a group consisting of adding to or enriching with at least one additive said drying air; drying said air; coalescent and conventional oil separating, liquid receiving and treating, eliminating pathogens by emitting NTP; filtering he air; contacting said air with a material-binding solid-phase or liquid-phase sorbents; bubbling air in a liquid phase for liquid extraction of a material; admixing material-binding agent with said inflowing air; and
wherein said material is selected from the group consisting of oxygen, carbon dioxide, hydroxyl-containing materials, esters, carboxylic acids, fatty acids, amino acids, peptides, terpenes, water-immiscible materials, materials miscible in organic solvents, ethylene, methane, aromatic materials, odors, nitrogen and nitrogen-containing materials, surfactants, volatile organic compounds, toxins, hazard materials, halogens, small particles, dust and fine particles, inorganic matter, pollen, dyes and pigments, insects and organs thereof, contaminations, magnetic materials, viruses, microorganisms, mixtures, and derivatives thereof.

67. The drying room of claim 50, wherein said crop is selected from the group consisting of a plant grown to be harvested, post-harvested, or used for any economic purpose, including agriculture crops, aquaculture crops, horticulture crops, floriculture crops, industrial crops, and any combination thereof.

68. The crop of claim 67, selected from the group consisting of crops intended for human or animal consumption, including human food and livestock fodder, for use as clothing, including fiber crops, for use as biofuel, including energy crops, algae fuel, for use in medicine, and for use as decorative, ornamental, or recreational plants, grain crops including cereals legumes, forage crops, fruits and vegetables, tree nuts, and oil, fat and wax crops, herbs and medicinal plants, including vanilla pods, lavender, Cannabaceae plants, including Cannabis plants and hop plants.
